(19) United States
(12) Patent Application Publication
(10) Pub. No.: US 2013/0041528 A1
(43) Pub. Date: Feb. 14, 2013

(54) Intelligent modular aerospace system

(71) Applicant: Edmund David Burke, Santa Maria, CA (US)

(72) Inventor: Edmund David Burke, Santa Maria, CA (US)

(21) Appl. No.: 13/507,773

(22) Filed: Jul. 25, 2012

Related U.S. Application Data
(60) Provisional application No. 61/574,812, filed on Aug. 8, 2011.

(51) Int. Cl. B64C 13/16

(52) U.S. Cl. 701/3

(57) ABSTRACT

An Intelligent Modular Aerospace System (IMAS) is a paradigm shift in the architecture, utility, efficiency, operation, test/checkout, qualification testing and adaptability of an aerospace application system that provides Time/Space/Position Information, Data Acquisition/Processing/Relay, Power Generation/Distribution, avionic solutions, navigation, and command/data handling. IMAS (10) as shown in FIG. 1 is comprised of open architecture stackable modules (12) which are interchangeable and connectable in any order, internally interconnected in a plug and play fashion with an internal raceway (14) containing an input access (16) and output access (18). The resultant IMAS is capable of ingesting any type of external power or data source such as GPS, IMU, communications, command functions and databases such as targeting information. IMAS output includes capabilities such navigation/control logic, avionics steering commands, autonomous flight and flight termination system commands, satellite inter-communications and power from within the modules.

### CROSS-REFERENCE TO OTHER RELATED APPLICATIONS

This application is the formal patent submission based upon the Provisional Patent No. U.S. 61/574,812 titled, “Intelligent Modular Aerospace System” filed on 8 Aug. 2011.

### BACKGROUND

### Prior Art

The following is a tabulation of some prior art that presently appears relevant:

| Pat. No. | Kind Code | Issue Date | Patentee |
|---|---|---|---|
| 5,534,366 | B1 | 1996-07-09 | Hwang et. al. |
| 6,043,629 | B1 | 2003-03-28 | Ashley et. Al. |

Current aerospace application systems operating in the realm of Time/Space/Position Information (TSPI), Data Acquisition/Processing/Relay (DA/P/R), Power Generation/Distribution (PG/D), avionics, navigation, command and data handling require a user to employ and maintain many individual self-contained component boxes, hereafter known as black-boxes to provide a singular however distributed capability for each individual desired TSPI, DA/P/R, avionics, command and data handling or PG/D function. The downside of this antiquated approach is that when a vehicle using such a fractionated suite of aerospace hardware requires an incremental or full upgrade to a particular TSPI, DA/P/R, avionics, navigation, command and data handling or PG/D system, it often requires years and a vast amount of funding to make the changes desired to adapt that TSPI, DA/P/R, avionics, navigation, command and data handling or PG/D hardware suite aboard that particular vehicle to its new and changing requirements. The many black-boxes comprising each single TSPI, DA/P/R, avionics, navigation, command and data handling or PG/D capability forces a customer into the extremely high cost of redeveloping and environmentally qualifying each of the many separate black-boxes which are part of the individual TSPI, DA/P/R, avionics, navigation, command and data handling or PG/D system, consistently resulting in an unnecessary and extremely large cost for an even incremental or minimal upgrade.

To the best of our knowledge, no prior art exists regarding an overall self-contained aerospace system such as an Intelligent Modular Aerospace System (IMAS) functioning in any TSPI, DA/P/R, avionics, navigation, command and data handling or PG/D role in one single integrated and consolidated box exhibiting the qualities of complete modularity, scalability, flexibility, stackability, interconnectivity, adaptability, reconfigurability and interchangeability in an intelligently consolidated manner which allows a customer to rapidly or even possibly meet a new mission requirement with their previous employed multiple black-box systems. There are however a very limited number of inventions addressing modular battery packs and modular control electronics for batteries. A modular battery pack invention by Hwang et. Al. only concerns itself with the physical mounting of interfaces for a battery's easier replacement. The modular control electronics for the battery invention of Ashley et al. only concerns itself with the modular control of charging each battery cell to protect the batteries and optimize their performance. Due to the nature of these inventions, neither of them can be adapted to the extent of the intent and demands that are required by this invention for the following reasons:

(a) Existing black-box systems do not incorporate methodology for isolating/combining/reconfiguring internal components either physically or via software command in the event that mission requirements change real-time, or if a black-box component has an internal failure.
(b) It is not possible to automatically protect any system component from a damaging source, either intended or unintended, which could cause irreversible harm to the integrated system.
(c) There is no system or method specified therein which is available to provide real-time monitoring/feedback on the health status of the contents of all components within their integrated configuration.
(d) The limiting design of existing systems precludes the rapid integration of external sensors or other sources desired to augment internal components or complete functions contained within a fractionalized black-box configuration.
(e) No capability exists for real-time data gathering from within integrated system subsets comprising a capability synthesized by the interaction of two or more components or modules within a wholly defined configuration.
(f) In addition to inefficiency problems that accompany the limiting factors encountered in fielding today's black-boxes, their ‘antiquated upon delivery’ nature also suffers from significant operations and maintenance issues and costs required to recondition and service components within the black-boxes.
(g) The closed and proprietary nature of today's black-box system long-lead time architecture is firmly based upon obsolete technology by its very nature, and is often size, weight and power (SWAP) excessive when compared to the rapidly evolving technologies which cannot be integrated and consolidated without major redesign and large cost.
(h) Present black-box configurations are limited to their individual unique manufactured unit, and do not allow for their rapid reconfiguration to a larger/smaller capacity, either physically or electronically.
(i) All present aerospace systems being black-box designs negate the possibility of their configuration into a modular “Lego” type system, either in a physical or electrical arrangement, thus increasing their design, implementation and qualification costs.
(j) Extreme launch environments cause present multiple black-box systems to undergo costly individualized pre-qualification testing to mitigate potential problems from surfacing in the operational employment of the fully fractionalized system.
(k) Present black-box architectures do not allow for a larger method of control aside from the immediate systems they are employed within, thus eliminating the possibility of mesh network control and redundant fail-over switching.
(l) Currently deployed black-boxes are incapable of providing real-time monitoring of health and status, thus precluding the capability to head-off and work-around an internal failure before it happens.
(m) Black-boxes as currently arranged in aerospace systems are not capable of being quickly combined with other system hardware in real-time in the event of a change in mission rules or a change in external interfaces.
(n) No fail-over/safe system exists to insure functionality if a single component or module fails within a distributed system of the black boxes.
(o) Space rated environmental qualification testing is complex and plagues all multiple black-box designs, forcing the designer into expensive qualification re-testing programs that have major schedule and cost impacts even if a tiny component and/or subsystem within a black-box is removed, changed or modified.
(p) Today's black-box combination systems cannot accommodate the capability for predictive performance in accordance with the number of cycles they have been subject to due to unique first-time combinations.
(q) Impacts of size and weight constantly arise during employment of existing multiple black-box systems, often resulting in the sacrifice of other mission capabilities.
(r) Query, reset, work-around, initializing, conditioning or reconfiguring is not possible within the confines of any of these prior art inventions, nor is it available at all within the industry.
(s) Current black boxes do not combine processor, communication, RF and power devices in one modular, stackable and reconfigurable system that can pass rigorous environmental (thermal, random and sine vibration, shock, etc.) and EMI/RFI testing.

### SUMMARY

The summation of all these lacking capabilities serve to indicate why no prior art regarding a self-contained aerospace system exists which exhibits the qualities of complete modularity, scalability, flexibility, stackability, interconnectivity, adaptability, reconfigurability and interchangeability to form an intelligent consolidated architecture which allows a customer to rapidly or even possibly meet a new mission requirement with their previously employed multiple black-box systems. Without the consolidation of multiple black box systems to bring a significant cost savings in development, aerospace environmental qualification, operation and maintenance for the life cycle of the technology application, then GPS tracking, autonomous flight and termination systems, space based range, avionics, navigation, nano/micro satellites, command and data handling, sensor data acquisition systems, telemetry, targeting and guidance systems for multiple aerospace platforms will not be practical and/or feasible utilizing the existing multiple black box architecture approach.

### ADVANTAGES

Accordingly, the main intention, object and advantage of this invention is that it incorporate all attributes necessary to make practical the qualities of modularity, scalability, flexibility, stackability, interconnectivity, adaptability, reconfigurability, consolidation and interchangeability which allows a customer the capability to rapidly deploy an aerospace component capability from scratch, and to then rapidly reconfigure this system whenever necessary to meet a new mission requirement which may come along at any time.

Employment of this approach allows for the rapid development and fielding of many systems previously considered impossible without this key enabling architecture in the TSPI, DA/P/R, avionics, navigation, command and data handling and PG/D realm to enable the transition from ground based component assets to a space-based infrastructure.

In addition to these clear advantages regarding our perception of the most practical approach that a completely modular, scalable, flexible, stackable, interconnected, adaptable, consolidated and interchangeable single box aerospace system should take the form of, this invention also benefits from the following important advantages:

(a) A complete and comprehensive intelligent capability is integral to the IMAS which isolates, combines, and reconfigures internal components in the event of an internal system failure or real-time mission change.

(b) An automatic protection system is inherent within any component or module level of functioning to preclude unintentional damage from occurring at any level within the functioning system.

(c) A complete employment of real-time monitoring and feedback methodology exists to insure that all on-board systems are performing as expected through all mission phases.

(d) The single integrated and consolidated box approach allows for instant communication access between any external sources or sensors that are required to interface with any particular component or system within the defined integrated modular and scalable box configuration.

(e) An immediate methodology is employed amongst any and all components in any configuration to allow for data to be gathered simultaneously or in an integrated fashion from any systems or subsystems down to the component level within the defined box configuration.

(f) The complete open architecture allows for state-of-the-art components to be installed within the defined system insuring a customer will always have the ability to receive the latest technological capability as it is fielded, and to have the option for upgrade at any time, thus making possible the greatest capability at the lowest price with the greatest life-cycle cost efficiency.

(g) The smartly integrated commercial off-the-shelf components are of the most recent manufacture and leading-edge capability imposing the most minimum footprint of any components possible on the market today.

(h) The completely flexible architecture enables an immediate physical or electronic reconfiguration capability for either testing or employment at any time, allowing for scaling up or down as a customer requires.

(i) The instantaneous connection capability both electronically or mechanically allows for an immediate modular arrangement or rearrangement at any time, and gives the ultimate flexibility to a customer who needs to keep design, implementation and qualification costs to an absolute minimum while gaining the most comprehensive capability possible.

(j) The prima facie capability evident in employing one box to do the job of many has far reaching scales of economy in weight reduction, qualification testing, troubleshooting, fielding and life cycle cost.

(k) Interconnection and communications flexibility allow for monitoring or control from any location in any configuration including any networking capabilities wishing to be exercised or employed on an operational basis.

(l) Fail-over scenarios are integral to the internal system workings, and can circumvent a possible failure from actually happening while status is being observed from an external viewpoint.

(m) Whenever any external events may trigger a change in flight planning or deployment, the system quickly and efficiently is capable of instantly adopting all new requirements and manifesting them into a newly defined set of parameters resulting in a redefined system in real-time which is capable of meeting all newly defined mission criteria and needs.

(n) The redundancy inherent in the system ensures that no single failure can occur which would result in the loss of a mission.

(o) The simplified single box approach allows for the single most efficient way to conduct any and all qualification/re-qualification testing at any level from a component piece through a completely integrated and consolidated single box system, independent and irrelevant of any new components which may or may have not become a new part of the newly defined system.

(p) The historical testing and fielding of this integrated and consolidated single box system has a large reliability database substantiating all components and their respective placements within the defined borders of the system at all levels, while absolutely minimizing the complexities involved of introducing new components.

(q) Impressive amounts of expensive vehicle real estate suddenly become available when employing this single box approach, allowing for notable system performance increases and accommodation of new payload capabilities while offering notable increased ease of system-wide employment.

(r) Complete access to all box functions are available via a direct data/telemetry monitoring capability on the ground or as the vehicle is in flight, thus giving increased confidence in all aspects of mission performance, while allowing for complete control or monitoring at any desired timeframe.

(s) This single-box approach combining all computational processing, RF, communications and power into one modular and reconfigurable stackable system enables the unit to undergo all environmental testing and flight certifications in a streamlined and expeditious way.

### DRAWINGS

### Figures

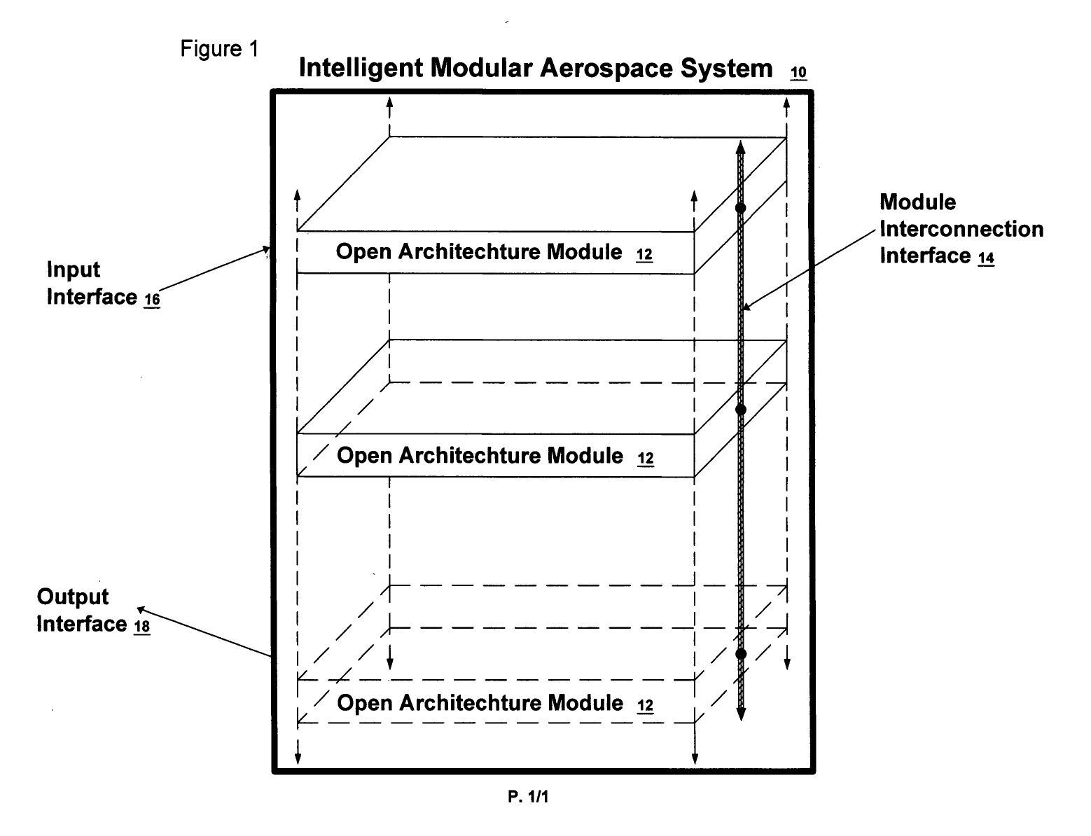

FIG. 1. is a three dimensional schematic block diagram functional layout illustrating the open architecture, capabilities and interactive nature of the IMAS.

### REFERENCE NUMERALS

10 intelligent modular aerospace system
12 open architecture module
14 module interconnection interface
16 input interface
18 output interface

### DETAILED DESCRIPTION

### FIG. 1

An intelligent modular aerospace system 10 as illustrated in FIG. 1 is comprised of any number of open architecture modules 12 interconnected via a module interconnection interface 14, with complete intelligent modular aerospace system 10 being capable of ingesting data via input interface 16 and outputting data via output interface 18.

### Operation—FIG. 1

Intelligent modular aerospace system 10 as illustrated in FIG. 1 is a manifestation of complex interchangeable hardware, software and firmware integrated and consolidated together in a manner to allow never-before combined functions such as Time/Space/Position Information (TSPI), Data Acquisition/Processing/Relay (DA/P/R), avionics, navigation, command and data handling and Power Generation/Distribution (PG/D) to reside in a single unit. Combining of all these functions to comprise the intelligent modular aerospace system 10 allows for unprecedented efficiencies in design, manufacture and space qualification testing to occur on a one-box system level, and provides for all components and capabilities within open architecture modules 12 to be instantly accessible for any reason. Module interconnection interface 14 is also of a complete open-architecture method, and can be arranged in any manner to interface with any or all open architecture modules 12 to obtain any desired results for operation of intelligent modular aerospace system 10.

Intelligent modular aerospace system 10 has an input interface 16 to ingest any type of external data source for processing and subsequently outputting an integrated system solution through output interface 18.

### ADVANTAGES

The above description distills the essence of the invention into the key component capabilities which illustrate the unprecedented qualities of complete modularity, scalability, flexibility, stackability, interconnectivity, adaptability, reconfigurability and interchangeability in an intelligent consolidated architecture into an aerospace application type of system, with more detailed qualities and capabilities being further described as follows:

1) A fail-safe design permeates all aspects of the IMAS including the integral system approach whereby internal and external structures function together in a deliberate synergistic interactive manner.

2) The system's design flexibility and implementation allows for any module configuration to employ safeguards which are interactive with any other module configuration which in turn absolutely minimizes the possibility of any damage permeating outside of a contained area

3) Health and Status data of all component monitor points continually provides a live view of the unit's internal workings through all employment scenarios.

4) All data sources external to the box singularly funnel into the system for ease of connectivity and speed of processing to further enhance the flexibility and employment capability of the unit.

5) Monitoring access of all pertinent components within the box or in combination with external interfacing data sources is available via an output data interface available real-time or delayed for post mission analysis.

6) The inherent design philosophy and implementation enables full flexibility for upgrades at the most minimal cost possible while maintaining superior system availability due to the ease which modifications can be employed.

7) By implementing cutting-edge systems, minimum real-estate is required which in-turn saves space, weight and cost, allowing for more payload aboard the vehicle.

8) Through all phases of employment, from build-up, system testing or flight, all electrical, mechanical, firmware or software can be adjusted with minimal impact to more finely tune the system to meet changing mission requirements.

9) The modular approach to this system allows for connection/disconnection in any configuration while maintaining the ability to monitor the new configuration instantly without any software modifications.

10) The playing field is leveled for all system users from very small to very large due to the simplistic design philosophy which permeates this system on all levels, namely the single-box approach tremendously saves on all aspects of development and employment.

11) Monitoring and control of the box from any location, close or remote is possible due to common communication protocols used extensively throughout the architecture, and which are transparent to module configuration or purpose.

12) Corrective actions within the unit can occur either while monitoring or while not being observed due to system functionality and robust backup capabilities.

13) Real-time reconfiguring within software is employed internally or externally via command if there are any last-minute mission changes which need accommodating, either pre-anticipated or not.

14) Mission success as well as safety is paramount in the design to preclude a simple non-lethal error from permeating throughout the system and causing uncontained damage which could endanger the mission.

15) One box, and one set of system qualification criteria is the guideline which distinguishes this box from any and all other multiple box systems whereby internal components can be modified and not impact any other systems external to the box, enabling only a simple incremental requalification if necessary at all.

16) Proven components integrated into a completely open modular design allows for minimal impact when it comes to upgrading a component within the system and zeroing out any possible complications which might have ordinarily occurred with multiple box systems where unknowns can be introduced between boxes due to modifications within one.

17) By shrinking the amount of space and weight required by this system, and always leaving the door open to further compression as components become smaller, the capability of this system continually increases as newer technologies becomes available and integrated into any new system requirements which may develop.

18) The integrated and consolidated skeletal approach to the design of the box makes all internal and external components of the box a part of the overall functioning system and as such immediately allows for common methods of monitoring to be employed during any phase of operation.

19) By integrating all the functional aspects of data processing, communications, RF and power into one stack, unmatched efficiencies are obtained in all testing and operational arenas during employment of the system.

### CONCLUSION, RAMIFICATIONS AND SCOPE

It is evident from the above description that the combination of virtues embodied in this invention are unsurpassed by anything available in the aerospace industry, and it serves to forge a new dimension and paradigm when it comes to the assemblage of components which comprise an aerospace use type system. For the first time in the aerospace industry, the data acquisition, computational and system interfaces are of a nature whereby the physical containment structure is integral with the components that comprise it and reside in it to make the whole system an integrated and consolidated system versus existing systems where the physical outer structure is merely a container to house components.

Of further note with this invention is the unprecedented ability to take its completed state and have ease of flexibility when it comes to integrating it into existing systems thereby replacing the cumbersome, costly and difficult to maintain array of black boxes currently employed today. The ease of incremental or full upgrades also paves the way for extreme cost reductions for employment and modifications on a global scale, with nothing even coming close to the capabilities made instantly possible with this invention.

it provides predictable and reliable operation through all aspects of employment in all defined environments the system is expected to function in, and has great reserve to function when expected tolerances are exceeded.

it affords comprehensive system protection from unintentional mishaps which may occur during any phase of operation, and depending on the incident, provide an automated course of action or make the opportunity available for rapid repair/replace methods to be implemented.

it enables full operational confidence to be achieved during all phases of the mission by providing a constant suite of measurements via hardwire or telemetry at anytime the system is powered on.

it is capable of ingesting or outputting data in an extremely simple and robust way through standard connectors and protocols, thus substantiating a system flexibility enabling the greatest ease of configurability and integration into an entire vehicle.

it offers the instant ability to monitor and troubleshoot any systems or configurations within the box via standard output connectors/protocols, and provide that data along with mission data to a common collection and analysis interface point.

it functions in a flexible manner to allow for incremental or full system upgrades, or even entire module interchanges on a moments notice without exposing the system to any operational or configuration control complexities or risks.

it offers the critical benefits of reduced size, weight and power consumption with exponentially increased reliability and processing power, all within a much smaller space than previous other black box systems occupied.

it is instantly adaptable to any sudden changes in mission needs, and allows for instant access to internal components as well as systems on a modular level requiring timely modification.

it is easily reconfigurable while utilizing existing automated software to instantly recognize and redefine all interfaces necessary to adapt to the new configuration.

it is usable on all aerospace vehicles from large to small, complex to simple, and is instantly adaptable to migrate between any of these vehicles at any time.

it allows for unprecedented insight into a system of this type whereby all internal and external systems related to the box can be analyzed remotely during any phase of its operation.

it comes from a robust design philosophy whereby capabilities are flowed downward to enable a full traceability of systems including a mapping of all interfaces and pathways for redundant operation.

it includes automated methodology to recognize the need for last minute changes in flight scenarios whether or not commanded externally, and to reconfigure all pertinent on-board systems to accommodate the new mission requirements.

it leverages fault-tree logic methods and captures them in its programming to insure that all module configurations are isolated from any possible migrating anomalies which could jeopardize mission success or safety.

its built-in nature of instant reconfigurability emulates a multiple box system's tolerance and robustness while advancing the benefits of sustained reliability and operational effectiveness that minimizes assembly, qualification testing and employment hours and costs.

it is capable of leveraging independent design solutions into a single system with a completely open architecture allowing for desired or mandatory upgrades to be accomplished within vetted interfaces to preclude any unanticipated interactions between components or modules or even multiple systems networked together.

it has an ability to take on new components or systems within the existing external structure or even be the catalyst for creating a new generation of smaller technological structures utilizing the exact methods presently defined.

it makes it possible to leverage the design philosophy whereby all aspects of the box structure are an active part of the external box design and strength matrix which is constantly monitored through all mission phases.

it enables rapid employment by presenting only one integrated and consolidated box for all qualification testing and installation into the vehicle and operation.

The many detailed descriptions above must not be interpreted in any manner to indicate a limit to the scope of this invention, as its only intent is to provide examples of the functionality obtained by employing such methods of employment. For example, the IMAS does not need to be terrestrially or airborne based, and could be utilized in a space environment for satellite applications or spaced based range operations. Although many specifics have been contained therein to help describe the functioning of this system, they should not be construed to confuse the main aspect of this invention that is the application of complete scalability, modularity, open architecture, flexibility, stackability, interconnectivity, reconfigurability, adaptability, interchangeability and consolidation in an aerospace application system within a single unit. For the first time in the whole history of the aerospace industry no longer will there be a reliance upon distributed unique black-box systems which very inefficiently provide the functions of TSPI, DA/P/R, PG/D, avionics, navigation, command and data handling. Additionally, these traditional black-box systems are of a nature whereby their internal components are simply housed in a box casing, opposed to the essence of this invention whereby the integrated and consolidated system is that of an inner and outer single structure which together comprises the totality of the complete system. Thus, the scope of this invention should only be determined by the appended claims and their legal equivalents.

I claim:

1. An integrated and consolidated modular aerospace system capable of providing time/space/position information, command and data handling, data acquisition/processing/relay, avionics solutions, navigation, power generation/distribution, said aerospace application system being self-contained in a consolidated and integrated single unit.

2. An aerospace system of claim 1 wherein said aerospace system is completely scalable, is modular in construction, has total open architecture, is completely flexible in reconfigurability and stackability along with being adaptable and allowing interchangeability with all components contained therein.

3. An aerospace system of claim 2 wherein said modules interconnect via an internal raceway means containing all power, communications and data required for functioning of said modules, said internal raceway means and said modules being infinitely expandable in the stacked configuration.

4. An aerospace system of claim 3 wherein a data processing means, communication means, an RF means and a power means are combined in one consolidated modular, stackable and reconfigurable system capable of passing rigorous aerospace environmental qualification testing including thermal cycle and vacuum, random and sine vibration, shock, and electro magnetic and radio frequency interference.

5. An aerospace system of claim 4 wherein said modules form a completely consolidated integrated structure with no external containment necessary.

6. An aerospace system of claim 5 wherein all vital internal functions of said aerospace system are monitorable externally via a data interface means.

7. An aerospace system of claim 6 wherein said aerospace system externally outputs all mission data via a data interface means.

8. An aerospace system of claim 7 wherein said aerospace system accepts data inputs from external sources via a data interface means.

9. An aerospace system of claim 8 wherein a design for manufacturability and a design for test provides unprecedented single integrated box efficiencies resulting in rapid construction, environmental qualification and test capability.
